(19) United States
(12) Patent Application Publication
(10) Pub. No.: US 2018/0247513 A1
(43) Pub. Date: Aug. 30, 2018

(54) APPARATUS AND SYSTEM FOR HOME AND COMMERICAL SYSTEMS MONITORING

(71) Applicants: Peter Calvert, London (CA); Marc Holbein, London (CA)

(72) Inventors: Peter Calvert, London (CA); Marc Holbein, London (CA)

(21) Appl. No.: 15/758,648

(22) PCT Filed: Sep. 8, 2016
(86) PCT No.: PCT/CA2016/051063

§ 371 Date: Mar. 8, 2018

Related U.S. Application Data
(60) Provisional application No. 62/215,327, filed on Sep. 8, 2015.

(51) Int. Cl. G08B 21/18

(52) U.S. Cl. CPC G08B 21/18; G08B 25/10

(57) ABSTRACT

According to some aspects, there is an electronic monitoring device for transmitting a digital alert signal. The device includes a power source for powering the electronic device, a sensor for generating a signal comprising trigger information a trigger detector configured to detect the trigger information, a processor configured to generate the digital alert signal based on the detected trigger information, and a transmitter for transmitting the digital alert signal to a communications network.

### TECHNICAL FIELD

The embodiments disclosed herein relate to apparatus and systems for home and commercial systems monitoring, and, in particular to apparatus and systems for monitoring household appliances, motors and pumps, and utilities.

### BRIEF DESCRIPTION OF THE DRAWINGS

The drawings included herewith are for illustrating various examples of articles, methods, and apparatuses of the present specification. In the drawings.

FIG. 1 is a schematic diagram of an electronic monitoring device for transmitting a digital alert signal;

FIG. 2A is a profile view of an electronic monitoring device according to some embodiments;

FIG. 2B is a top plan view of the electronic monitoring device of FIG. 2A;

FIG. 2C is a profile view of the electronic monitoring device of FIG. 2A;

FIG. 3 is a schematic diagram of a system for monitoring sensor signals and transmitting a digital alert signal according to one embodiment;

FIG. 4 is a schematic diagram of a system for monitoring sensor signals and transmitting a digital alert signal according to one embodiment;

FIG. 5 is a schematic diagram of a system for monitoring sensor signals and transmitting a digital alert signal according to one embodiment;

FIG. 6 is a schematic diagram of a system for monitoring sensor signals and transmitting a digital alert signal according to one embodiment; and

FIG. 7 is a schematic diagram of a system for monitoring sensor signals and transmitting a digital alert signal according to one embodiment.

### DETAILED DESCRIPTION

Various apparatuses or processes will be described below to provide an example of various embodiments. No embodiment described below limits any claims and any claim may cover processes or apparatuses that differ from those described below. The claims are not limited to apparatus or processes having all of the features of any one apparatus or process described below or to features common to multiple or all of the apparatus described below. It is possible that an apparatus or process described below is not an embodiment of any claim. Any embodiment disclosed below that is not claimed in this document may be the subject matter of another protective instrument, for example, a continuing patent application, and the applicants, inventors or owners do not intend to abandon, disclaim or dedicate to the public any such material by its disclosure in this document.

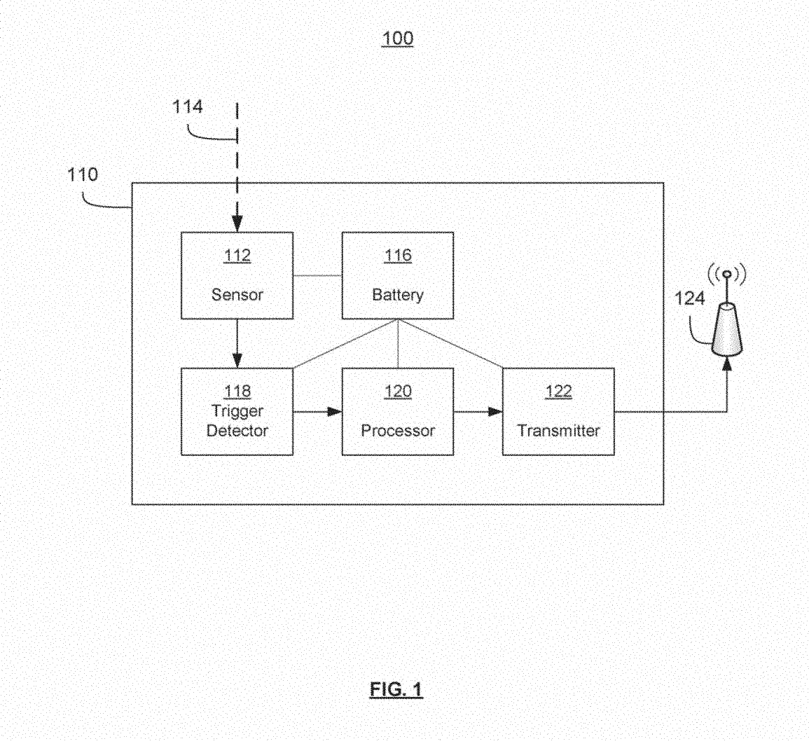

Referring to FIG. 1, illustrated therein there is a device 110 for monitoring home systems and utilities and transmitting a digital alert signal according to some embodiments.

The device 110 comprises a sensor 112, which, according to some embodiments, detects a particular physical, chemical, or other environmental condition 114. A trigger detector 118 is used to determine when the environmental condition 114 meets a particular criterion. When the trigger detector 118 determines that the criterion is met, a processing unit 120 generates a digital alert message. The digital alert message is then transmitted to a communications network using a transmitter 122.

The digital alert message may be transmitted over a communications network such as a cellular telephone network, the Internet, a local-area network (LAN), a wide-area network (WAN), a personal-area network (PAN), and which may use various communications technologies, such as WI-FI, ZigBee®, and Bluetooth® low energy (BLE), etc.

In the case of a cellular telephone network, according to some embodiments, the digital alert message may be in the form of a text message (e.g. an SMS), a recorded voice message, or email message, etc. In such an example, the device 110 is associated with a particular phone number or numbers to which the digital alert message may be sent, in some cases to a server, in other cases directly to a user. In some examples, a second message (which could be an email, SMS or other message format) may be sent from the server to a user or to another designated individuals based on a protocol stored on the server.

According to some embodiments, the transmitter 122 may be a GSM or other cellular network protocol transmitter, which may transmit a wireless signal using an antenna 124.

In the case of the Internet, LAN, etc., the digital alert message may be in the form of an email, or other messaging protocol. According to some embodiments, the message may be sent to an application on a mobile device. In such a case, a user may install an application on a mobile device (e.g. a mobile phone, tablet, etc.) that displays the status of the device 110. According to some alternative embodiments, the message may be delivered to a website, such that a user can log in to the website with particular login credentials, and then use the website to monitor the status of a device 110 associated with the particular user.

According to some embodiments, the transmitter 122 may be a transmitter configured for Internet networking protocols, such as TCP/IP. In some cases, this may include a wired or wireless transmitter, which may require the use of an antenna 124. The transmitter 122 and/or antenna 124 may be configured to use one or both cellular phone and Internet messages

A particular type of sensor may be selected for use as the sensor 112, depending upon the intended application. For example, according to some embodiments, the sensor 112 may be a scale (e.g. for sensing mass), a light sensor (e.g. infrared detector), an accelerometer, a water detector (e.g. for sensing the presence of water), an electrical current or impedance sensor, a vibration sensor, a water-level sensor (e.g. for sensing the change or rate of change in a water level within a container), or a temperature sensor.

According to some particular embodiments, the sensor 112 may be a scale (e.g. for sensing mass), for example, for use in the detection of a parcel or postal delivery. In this example, when an item such as a package or mail is placed on the scale, the device 110 sends a message to indicate that the package or mail had been delivered, so that, the recipient of the package or mail can be notified that the parcel or mail is available for pickup. For example, a device 110 equipped with a scale could be used in a mailbox at a remote location so that the owner of the mailbox could avoid unnecessary trips to the mailbox when it is empty, such as may be the case in rural settings, urban settings with centralized community lock-box mail boxes apartment or condominium buildings where mail is delivered to mailboxes in the lobby, etc.

In other embodiments, the sensor 112 may include one or more optical sensors or infrared proximity sensors for detecting mail or other objects. For example, one or more LEDs may be used to detect whether mail has been inserted into or removed from a mailbox.

According to some embodiments, the sensor 112 may be a pressure mat, for example, for use in the detection of pressure, such as may be applied by a person walking on the mat. In this example, the pressure mat may be placed adjacent to a door or other opening in a house, trailer boat, etc. When a person steps on the mat, the device 110 sends a message to indicate that someone has entered the house, trailer, boat, etc. through the door.

According to some embodiments, the sensor 112 be a water detector, such as may detect the presence of water. For example, a water-detector sensor 112 may be used in applications in which a flood or water leak may be a sympton of a particular problem, such as a flooded basement (perhaps when a sump pump is malfunctioning), an over-flowing appliance (e.g. laundry machine, dishwasher, etc.) that is not draining properly, or a burst water supply or drain line. In cases where the device 110 is equipped with a water detector, the device 110 could be used to provide an alert that water as been detected, and which may automatically trigger a shut-off valve or other corrective action.

According to some embodiments, the sensor 112 may be an electrical current sensor, or another electrical sensor that is capable of detecting a closed circuit versus an open circuit, such as an impedance detector. An electrical current sensor (or impedance sensor) may be used in applications in which the detection of a power failure can be used to identify a particular problem. For example, a device 110 equipped with this type of sensor 112 could be used to send an alert when the main power supply to a building has failed, when a particular circuit within a house has failed (e.g. the breaker switch has been opened), or when the power supply to a particular appliance has been disconnected.

According to some embodiments, the sensor 112 may be a vibration sensor, such as may measure the amplitude of mechanical vibrations. Such a sensor could be used in order to detect abnormal operation of mechanical equipment such as a motor. For example, a device 110 could be configured such that the sensor 112 measures the vibration of a motor, and the trigger detector 118 determines when the vibrations are above a particular threshold, or deviate significantly from a baseline established for a motor that is properly functioning. In this configuration, if the motor starts to vibrate abnormally (e.g. as a symptom prior to the failure of the motor), an alert can be sent so that the motor can be inspected, repaired, or replaced as necessary prior to a more substantial problem resulting from a failure of the motor. A device 110 can also be configured such that the trigger detector 118 determines when the vibrations are below a particular threshold (or when the vibrations have stopped altogether) in order to send an alert that a particular motor has failed or is otherwise malfunctioning. Such devices may be useful in applications involving pump motors, compressors (e.g. for refrigeration), blower fans (e.g. for heating, ventilation, and air-conditioning systems), etc.

In some embodiments, a vibration sensor (i.e., an accelerometer) may be used to detect flow of fluid in pipes (i.e., water, gas, etc.) and discern whether a particular pipe is blocked, or if flow is restricted. This may be used, in one specific example, as an indicator of sump pump system health.

According to some other embodiments, the sensor 112 may be a water-level sensor such as may measure the change in a water level within a tank or container, or as may measure the rate of change in the water level. For example, a device 110 equipped with a sensor 112 for measuring a water level may be applicable to a situation involving a sump pump well. In such a case, alerts could be sent using the device 110 based on a particular water-level threshold, or a particular rate-of-change threshold. Similarly, a device 110 equipped with a sensor 112 for measuring the level of a liquid may also be applicable in situations in which a liquid fuel is used, such as in a diesel generator, in order to send an alert prior to the generator running out of fuel. In a similar manner, the level of other materials (such as solids) in particular container could also be measured.

According to some embodiments, the sensor 112 may be a temperature sensor. A device 110 equipped with a sensor 112 for measuring temperature may be useful in situations involving refrigeration, and heating, ventilation, and air-conditioning terns. For example, such a device 110 could be placed in a freezer or refrigerator, so that an alert could be sent when the temperature inside the freezer or refrigerator surpasses a particular threshold, thereby helping to identify that the freezer or refrigerator is malfunctioning. Similarly, a device 110 with a temperature sensor could be used to send an alert when the ambient temperature of a room surpassed a particular threshold. Alerts may be sent with regards to the onset of freezing temperatures (e.g. to prevent frozen pipes), or to assist in the early identification of a problematic heating, ventilation, or air-conditioning system. Similarly, the sensor 112 may include a sensor for measuring other atmospheric conditions, such as air pressure, relative humidity, the presence of Volatile organic compounds (VOCs), carbon monoxide (CO), and other measurable parameters.

According to some embodiments, the sensor 112 may be a light sensor, such as an infrared sensor. A device 110 equipped with a sensor 112 for measuring light may be useful in situations involving motion or changes in ambient light. For example, such a device 110 could be placed in a mailbox, so that an alert could be sent when the mailbox door was opened (e.g. change in ambient light), or when a hand, parcel, or other object was placed inside the mailbox (e.g. detecting motion).

According to some embodiments, the sensor 112 may be an inertial sensor such as an accelerometer. A device 110 equipped with an inertial sensor may be useful in situations involving motion. For example, in a large community mailbox with a gang door, the inertial sensor could be used to detect when the gang door is opened (e.g. when the postal carrier opens the gang door in order to delivery individual mail items to individual mail boxes). The detection of the gang door could be used to “wake up” (turn on the power to other sensors (e.g. scales and/or light sensors) within each individual mailbox, which may be useful for power management.

Turning once again to FIG. 1, in some embodiments a battery 116 is used to power the device 110. According to some embodiments, the battery 116 may be included in order to power the device during times when no other or a limited electrical supply is available to the house or to the device 110. For example, if the device 110 is being used to detect a loss of electrical power, the battery 116 must be capable of supplying power to the device 110 even during this period of lost electrical power (e.g. when an electrical utility providing power to a house has failed, or when a particular electrical circuit in a house is open, etc.)

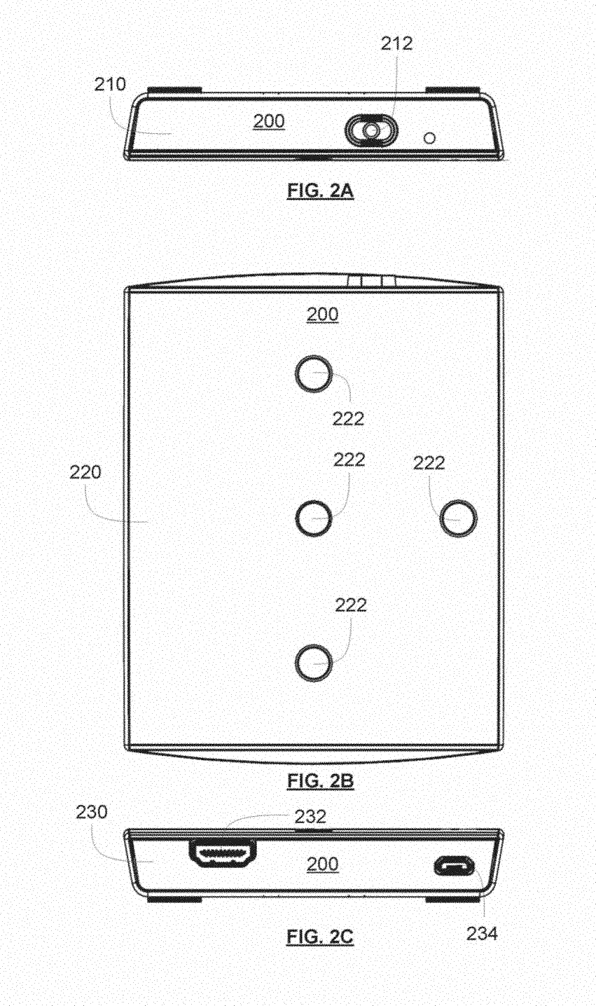

Referring to FIG. 2A, FIG. 2B, and FIG. 2C, there is shown a device 200 for monitoring home systems and utilities and transmitting a digital alert signal according to some embodiments. The device 200 may be used, for example, in a mailbox at a remote location so that the owner of the mailbox could avoid unnecessary trips to the mailbox when it is empty, or in other applications as generally described herein.

A first face 210 of the device 200 is shown in FIG. 2A. A top 220 of the device is shown in FIG. 2B. A second face 230 is shown in FIG. 2C.

A button or switch 212 may be located on the first face 210, in order to provide a power on/off switch, a reset switch, or other basic input to the device 200. According to some embodiments, power may be supplied from an external source through the power connection 234, which may be located on the second face 230, according to some embodiments.

The power correction 234 may be connected to a battery or other local power storage/supply internal to the device 200 so that the device 200 can temporarily function even when there is no power supplied to the power connection 234.

Holes 222 may be located on the top 220 of the device 200 in order to accommodate are infrared proximity detector or other sensor. In some embodiments, the infrared proximity detector may be used for detecting that mail has been placed into or taken out of a mailbox containing the device 200. For example, three holes 222 may be used for infrared lights, and a fourth hole 222 may be used for the infrared sensor.

The device 200 may also include a data connector 232 that, according to some embodiments, may be located on the second face 230. For example, the data connector 232 may be an HDMI® connector, which may provide one or two-way data connection with another transceiver as a part of a system for home or commercial system monitoring.

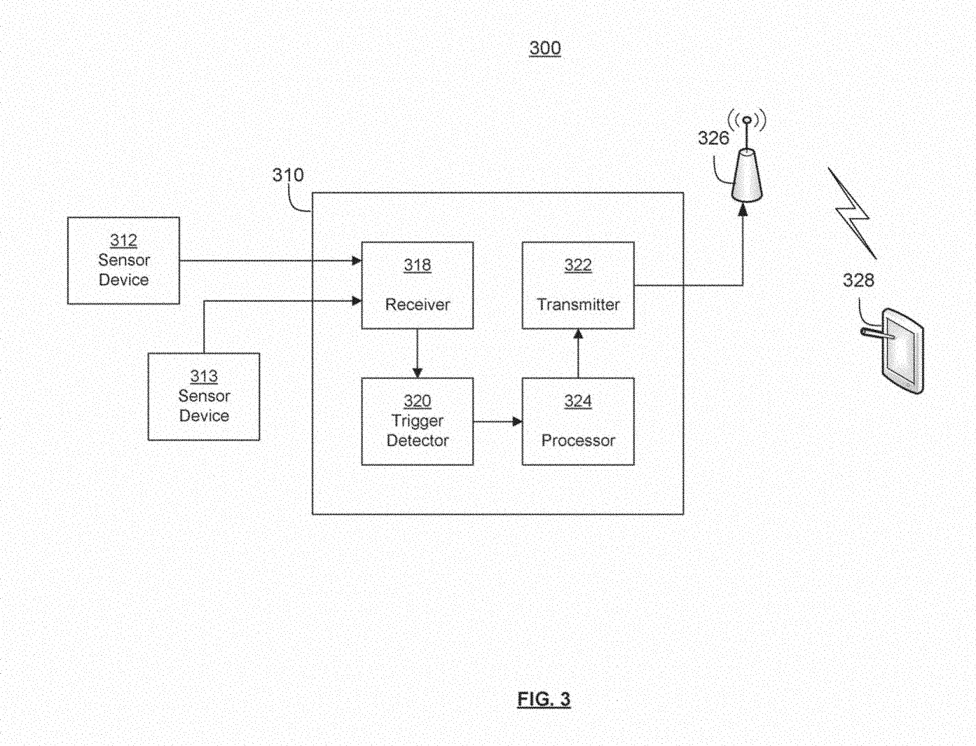

Referring to FIG. 3, there is a system 300 for monitoring sensor signals and transmitting a digital alert signal. The system comprises a device 310 for transmitting digital alert signals and two sensor devices 312, 313 in communications with the device 310. It practice, the system 300 is not limited to two sensor devices 312, 313, but is shown with only two sensor devices 312, 313 in FIG. 3 for the sake of illustration.

According to some embodiments, each of the sensor devices 312 and 313 may comprise various types of sensor, such as a scale (e.g. for sensing mass), a water detector (e.g. for sensing the presence of water), an electrical current sensor, a vibration sensor, a water-level sensor (e.g. for sensing the change or rate of change in a water level within a container), a temperature sensor, and so on.

Furthermore, particular combinations of sensor types may be advantageous. For example, a water-level sensor in combination with an electrical current (or impedance) sensor may be helpful towards identifying causes of a flooded basement. If an alert is sent due to a rising water level, but no alert is received to indicate a power failure with the sump pump, the available information can be used to determine that the problem is not with the power supply to the sump pump. Similarly, an alert sent in response to a detected vibration in a fan motor, in combination with an alert sent due to a low temperature, may be helpful in determining that a furnace is functioning properly, and that the problem is in the blower fan.

The sensor devices 312 and 313 are connected to a receiver 318 of the device 310. The receiver 318 receives signals from the sensor devices 312 and 313 that indicate the current status of the sensor through trigger information. For example, if the sensor device 312 is a temperature sensor, then the receiver 313 receives a signal based on the temperature that is sensed. Similarly, if the sensor device 313 is a water detector, then the receiver 318 receives a signal based on whether water has been detected.

The receiver 318 is in communication with a trigger detector 320. The trigger detector 320 is configured to detect trigger information from the sensor devices 312 and 313. For example, if the sensor device 312 is a temperature sensor, the trigger detector 320 may be configured with a threshold temperature, such that, when the trigger information received from the sensor 312 is above the threshold temperature, the trigger detector 320 determines that an alert will be sent. If the sensor device 313 is a water detector, then the trigger detector 320 may determine that a message will be sent based on the presence of any water, as indicated by the trigger information.

According to some embodiments, the trigger detector 320 may be configured to detect whether the trigger information is within a tolerance window. In other words, the trigger detector 320 may be configured with both an upper threshold and a lower threshold, such that an alert will be sent when the trigger information is above the upper threshold or below the lower threshold. For example, this may be useful when the sensor device 312 is a temperature sensor, and a preferred temperature range (i.e. tolerance window) is desired. According to other embodiments, an alert may be sent when the trigger information is outside the tolerance window.

The trigger detector 320 is in communication with a processor 324. The processor 324 is configured to generate a digital alert signal when the trigger detector 320 determines that an alert signal will be sent.

According to some embodiments, the processor 324 may generate an alert signal that indicates a simple binary alarm (e.g. “on” or “off”). For example, the alert signal may indicate that water has been detected, or that an electrical circuit is open (e.g. disconnected power supply or power failure), that a package has been delivered (e.g. as determined by a scale or optical/infrared sensor), that a threshold temperature has been surpassed, etc.

It is also possible that the alert signal may indicate further details of the situation to which the alert pertains. For example, the alert signal may indicate the actual temperature or water level that has been measured, the duration over which the condition has been experienced, etc. According to some embodiments, the sensor measurements may be included in an alert signal that is sent regardless of whether a threshold condition has been surpassed.

The processor 324 communicates the alert signal to a transmitter 322, which transmits a message including the alert signal over a communications network 326 to a receiving terminal 328. According to some embodiments, the communications network 326 may include a server that receives a first message from the transmitter 322, interprets the message from the transmitter 322, and then sends a corresponding message to the receiving terminal 328 based on the first message sent from the transmitter.

According to some embodiments, receiving terminal 328 may be a computer (e.g. connected on the internet), or a mobile communications device such as a mobile phone or tablet, operating on a wireless network 326 such as a cellular network or other wireless network (e.g. IEEE 802.11).

The processor 324 may be configured to produce a particular type of alert message that correspond to a particular protocol of the transmitter 322, a particular communications network 326, or a particular type of receiving terminal 328.

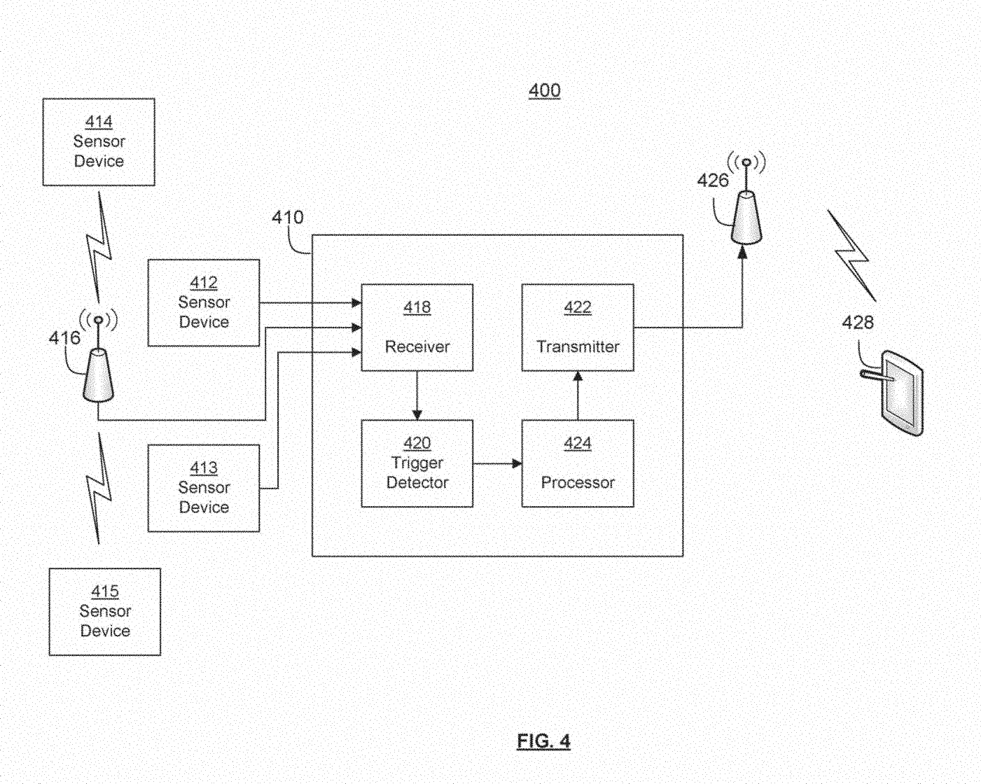

Referring to FIG. 4, illustrated therein is a system 400 for monitoring sensor signals and transmitting a digital alert signal. The system 400 comprises wired sensor devices 412 and 413 that are electrically connected to the receiver 418, as well as wireless sensor devices 414 and 416, which are connected to the receiver 418 via an antenna 416.

According to some embodiments, the receiver 418 may be configured to receive signals using wireless protocols such as the Bluetooth®, ZigBee® (i.e., IEEE 802.15.4) protocol. The receiver 418 may also be configured to receive signals based on electrical connections, such as an HDMI® cable.

The use of multiple connection types may be useful in providing access to various types of sensor devices, and particular combinations of sensor devices. For example, a wireless sensor device 414 may include an electrical current sensor, which may be physically separate from the device 410 in the system. Furthermore, the sensor device 412 may include a water-level sensor, which may be physically connected to the device 410 using an HDMI cable interface.

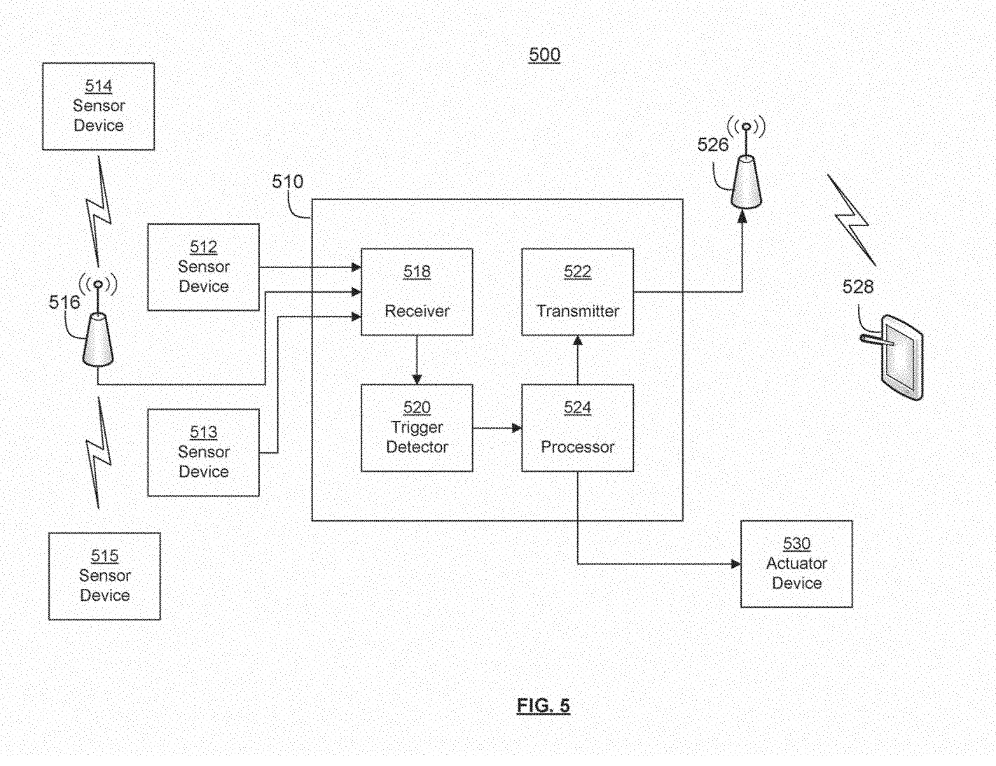

Referring now to FIG. 5, illustrated therein is a system 500 for monitoring sensor signals and transmitting a digital alert signal. The system 500 includes an actuator device 530, such as a solenoid valve actuator. According to some embodiments, the actuator device 830 may be used to automatically address a particular problem, in addition to the alert message that is sent by the transmitter 522. For example, the sensor device 514 may include a water sensor that is located in a pan underneath a dishwasher, and the actuator device 530 may be a solenoid valve actuator connected to the water supply line running to the dishwasher. In the event that the trigger detector 520 determines that water is present, the processor 524 may generate an alert message, and may also send a signal to the actuator device 530 to shut off the water supply line (generally automatically without any user intervention). In this way, an alert message is sent indicating that there is water collecting under the dishwasher, and, at the same time, an attempt is made to prevent subsequent water damage from the flooding dishwasher.

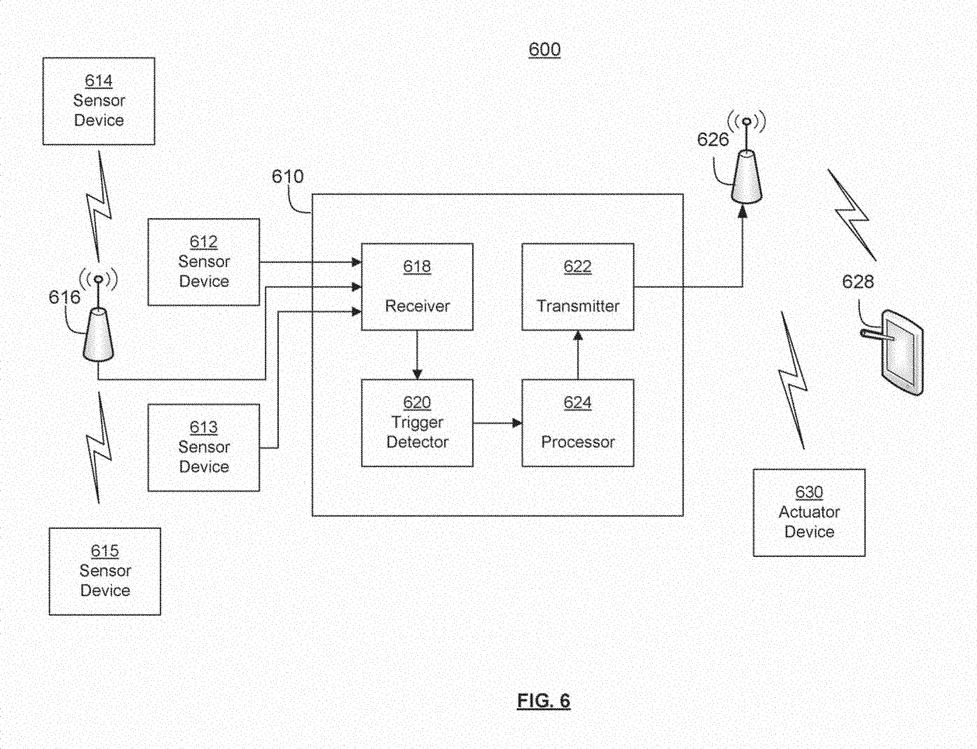

Referring now to FIG. 6, illustrated therein is a system 600 for monitoring sensor signals and transmitting a digital alert signal. According to some embodiments, the system may include an actuator device 630 that is in wireless communications with the device 610. For example, the actuator device 630 may be in communication with the device 610 using a short-range connection (e.g. Bluetooth) or medium-range connection (e.g. IEEE 802.15.4 ‘Zigee’), and/or the actuator device 630 may be in communication with the device 610 using the same communication network as is used by the receiving terminal 628 (e.g. cellular network, Internet, LAN, WiFi, etc.).

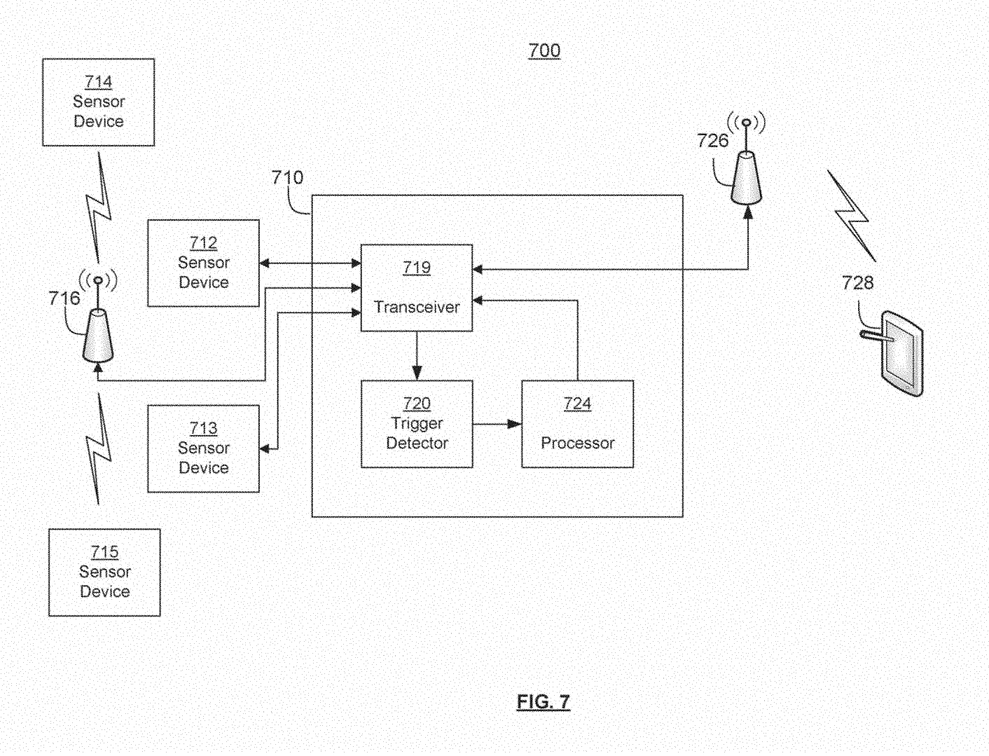

Referring to FIG. 7, shown there is a system 700 for monitoring sensor signals and transmitting a digital alert signal. According to some embodiments, a device 710 for transmitting digital alert signals may comprise a transceiver 719 for two-way communications with any or all of the sensor devices 712 and 713, the wireless sensor devices 714 and 715, and the receiving terminal 728. The use of a transceiver 719 enables the system to dynamically adjust the sensor devices 712, 713, 714, and 715 based on input from a user of the receiving terminal 728.

For example, if the sensor device 112 includes a temperature sensor for measuring the ambient temperature of a room in order to determine if the room is overheating, then the receiving terminal 728 can be used to set or adjust the threshold temperature at which the trigger detector 720 determines that an alert signal will be sent. Similarly, if the sensor device 714 includes a temperature sensor for measuring the ambient temperature of a room in order to determine if pipes are likely to freeze, then the receiving terminal 728 can be used to deactivate the sensor 714 during times when the temperature is unlikely to go below the freezing point.

The teachings herein may be useful in various particular applications as will be generally appreciated by persons of skill in the art. For instance, one exemplary application includes the detection of water intrusion in a structure such as a trailer, apartment, office building, warehouse or a factory.

One such example could include a main device with a virtually unlimited number of remote sensors that are in communication with the main device using Bluetooth Low Energy (BLE) or another protocol. The sensors can be configured to detect motion (i.e., via an accelerometer), temperature, humidity, and other parameters. The use of BLE could allow for meshing functionality in which a message from one sensor can be relayed through adjacent sensors to the main device for processing (i.e., so that a notification can be sent). Protocols such as ZigBee® may also be used for meshing, but may not be as ubiquitous as BLE.

In one specific example, an apartment building with 10 floors and 10 units per floor could place sensors in each unit and have them report water intrusion back to the main device via a meshing network.

In another particular application, the teachings herein could be used to detect liquid flow in a pipe. For instance, in a sump pump application where liquid is flowing, one or more sensors could be coupled to a pipe, and the main device could be programmed to “learn” the normal operating flow of liquid through the pipe using the vibration readings registered on the sensor based on the observed vibration signature. When the signature deviates beyond a certain value, an alert can be generated that there may be an issue with fluid flow (i.e., a blockage). In some examples, this type of monitoring could be used in conjunction with monitoring a pump motor itself so that, if the motor is running and there is no flow, a notification can be sent. This could be an indication that the impeller might be broken or the pipe is blocked.

In another specific application, the teachings herein could be used for level sensing in a container, whether liquid or solid. For example, the main device could be configured to communicate with a level sensing chip that can allow for low and high points to be set, and then report the level of the material within the container. This could be useful in a sump pump well application where the device can sense when water is starting to rise (i.e., the water hits the low point), and monitoring can continue to escalate warnings, as the water rises to (and past) the high point. Such a sensing wire need not be in contact with the material, and hence this approach could be used for both solid and liquid applications.

One specific example would be a diesel fuel tank that is connected to an engine driving an emergency power generator. Placing a wire on the outside of the tank can for warnings) be generated as the tank empties.

Another specific example is a hopper that fills with sand and, once full, needs to be dumped. Placing a wire on the outside of the hopper can allow for monitoring the sand level and triggering it to be dumped (in some cases automatically). The same approach could be used with a garbage container or a used cooking oil tank at a restaurant. When the container or tank fills, a notification can be sent to schedule a pickup.

Another specific application includes swimming pool intrusion, where the device can monitor whether an animal (human being or otherwise) has entered the water based on disturbances to the level of the water or by monitoring other parameters.

While the above description provides examples of one or more apparatus, methods, or systems, it will be appreciated that other apparatus, methods, or systems may be within the scope of the claims as interpreted by one of skill in the art.

1. An electronic monitoring device for transmitting a digital alert signal, comprising:
a power source for powering the electronic device;
a sensor for generating a signal comprising trigger information;
a trigger detector configured to detect the trigger information;
a processor configured to generate the digital alert signal based on the detected trigger information; and
a transmitter for transmitting the digital alert signal to a communications network.

2. The electronic device of claim 1, wherein the sensor is a scale for detecting a mass, the trigger information is based on the detected mass, and the trigger detector is configured to detect when the detected mass is at least one of above and below a threshold mass.

3. The electronic device of claim 1, wherein the sensor is water sensor for detecting the presence of water, the trigger information is based on the detected presence of water, and the trigger detector is configured to detect when water is present.

4. The electronic device of claim 1, wherein the sensor is an electrical current sensor for detecting electrical current, the trigger information is based on the detected electrical current, and the trigger detector is configured to detect when the electrical current is zero.

5. The electronic device of claim 1, wherein the sensor is a vibration sensor for detecting a magnitude and/or spectral frequency content of vibration, the trigger information is based on the detected magnitude of frequency components of vibration, and the trigger detector is configured to detect when the magnitude of vibration is at least one of above and below a threshold magnitude.

6. The electronic device of claim 1, wherein the sensor is a liquid-level sensor for detecting a change in a liquid level, the trigger information is based on the detected change or rate of change in the liquid level, and the trigger detector is configured to detect when the change in the liquid level is at least one of above and below a threshold liquid-level change.

7. The device of claim 1, wherein the sensor is a temperature sensor for detecting a temperature, the trigger information is based on the detected temperature, and the trigger detector is configured to detect when the temperature is one of either above or below a threshold temperature.

8. A system for monitoring sensor signals and transmitting a digital alert signal, comprising:
a first sensor and a second sensor each in communication with a device for transmitting a digital alert signal, the first sensor generating a first signal comprising a first trigger information, and the second sensor generating a second signal comprising a second trigger information;
the device for transmitting alert signal, comprising:
a receiver for receiving the first signal from the first sensor and the second signal from the second sensor;
a trigger detector configured to detect at least one of the first trigger information and the second trigger information;
processor in communication with the trigger detector, the processor configured to generate the digital alert signal based on at least one of the first detected trigger information and the second detected trigger information; and
transmitter for transmitting the digital alert signal to communications network.

9. The system of claim 8, wherein the first sensor is a first electrical current sensor for detecting electrical current in a first circuit, and the second sensor is a second electrical current sensor for detecting electrical current in a second circuit.

10. The system of claim 8, wherein the first sensor is a water sensor for detecting a presence of water, and the second sensor is an electrical current sensor for detecting electrical current.

11. The system of claim 8, wherein the first sensor is a water sensor for detecting a presence of water, and the second sensor is a vibration sensor for detecting mechanical vibration.

12. The system of claim 8, wherein the first sensor is an electrical current sensor for detecting electrical current, and the second sensor is a vibration sensor for detecting mechanical vibration.

13. The system of claim 8, wherein the first sensor is a water sensor for detecting a presence of water, and the sensor is a water level sensor for detecting a change in a water level.

14. The system of claim 8, wherein the first sensor is an electrical current sensor for detecting electrical current, and the second sensor is a water level sensor for detecting a change in a water level.

15. The system of claim 8, wherein the first sensor is a vibration sensor for detecting mechanical vibration, and the second sensor is a water level sensor for detecting a change in a water level.

16. The system of claim 8, wherein the first sensor is a water sensor for detecting a presence of water, and the second sensor is a temperature sensor for detecting a temperature.

17. The system of claim 8, wherein the first sensor is an electrical current sensor for detecting electrical current, and the second sensor is a temperature sensor for detecting a temperature.

18. The system of claim 8, wherein the first sensor is a vibration sensor for detecting mechanical vibration, and the second sensor is a temperature sensor for detecting a temperature.

19. The system of claim 8, wherein the first sensor is a water level sensor for detecting a change in a water level, and the second sensor is a temperature sensor for detecting a temperature.

20. The system of claim 8, further comprising solenoid valve actuator in communication with the processor, wherein the processor further configured to generate an action signal based on at least one of the first detected trigger information and the second detected trigger information, and wherein the solenoid valve actuator is activated by the action signal.
